(19) United States
(12) Patent Application Publication
(10) Pub. No.: US 2026/0279862 A1
(43) Pub. Date: Sep. 17, 2026

(54) FUEL CELL SYSTEM AND CONTROL METHOD THEREOF

(71) Applicant: HONDA MOTOR CO., LTD., TOKYO (JP)

(72) Inventors: Hikaru WATANABE, WAKO-SHI (JP); Yuki IWAO, TOKYO (JP)

(21) Appl. No.: 19/564,949

(22) Filed: Mar. 12, 2026

(30) Foreign Application Priority Data
Mar. 14, 2025 (JP) 2025-040898

(51) Int. Cl. H01M 8/04992; B60L 53/54; B60L 58/40; H01M 8/04223; H01M 8/04302; H01M 8/0432; H01M 8/04492; H01M 8/04746; H01M 8/04828; H01M 8/04858; H01M 8/10; H01M 10/46; H01M 16/00

(52) U.S. Cl. CPC H01M 8/04992; B60L 53/54; B60L 58/40; H01M 8/04253; H01M 8/04302; H01M 8/0432; H01M 8/04492; H01M 8/04753; H01M 8/04828; H01M 8/0488; H01M 10/46; H01M 16/006; H01M 2008/1095; H01M 2220/20; H01M 2250/20; H01M 2250/402

(57) ABSTRACT

A fuel cell system makes a flow rate of a cathode gas that is increased in a voltage recovery control smaller at low-temperature startup until a fuel cell stack reaches a predetermined water-content state than the flow rate of the cathode gas that is increased at the normal startup.

### CROSS-REFERENCE TO RELATED APPLICATIONS

This application is based upon and claims the benefit of priority from Japanese Patent Application No. 2025-040898 filed on Mar. 14, 2025, the contents of which are incorporated herein by reference.

### BACKGROUND OF THE INVENTION

### Field of the Invention

The present disclosure relates to a fuel cell system that generates electric power by way of electrochemical reactions that take place between a cathode gas and an anode gas, and a control method of the fuel cell system.

### Description of the Related Art

In recent years, research and development have been conducted on fuel cells (FCs) that contribute to energy efficiency in order to ensure that more people have access to affordable, reliable, sustainable and modern energy.

For example, JP 2010-123430 A discloses a technique for recovering the voltage of a fuel cell stack by increasing the flow rate of air (cathode gas) when flooding is occurring in the fuel cell stack and the voltage of the fuel cell stack is lowered (see, for example, paragraph 0037 of JP 2010-123430 A).

### SUMMARY OF THE INVENTION

When the fuel cell stack is started up at a low temperature, the activity of the electrode catalyst is unstable. Therefore, when the stack voltage decreases in an unstable state, if the amount of increase in the cathode gas is not appropriate, the fuel cell stack may become more unstable.

The present disclosure has the object of solving the aforementioned problem.

According to one aspect of the present disclosure, a fuel cell system including a fuel cell stack configured to generate electric power by reactions between an anode gas and a cathode gas, wherein the fuel cell system performs a low-temperature startup control in a case where a temperature of the fuel cell stack is lower than a low-temperature threshold, performs a normal startup control in a case where the temperature is equal to or higher than the low-temperature threshold, and performs a voltage recovery control of the fuel cell stack by increasing a cathode gas flow rate in response to a voltage drop of the fuel cell stack at the low-temperature startup by the low-temperature startup control or at normal startup by the normal startup control, and wherein an increase in the cathode gas flow rate in the voltage recovery control during the low-temperature startup until the fuel cell stack reaches a predetermined water-content state is set to be smaller than an increase in cathode gas flow rate in the voltage recovery control during the normal startup.

According to another aspect of the present disclosure, a control method of a fuel cell system, including: a voltage drop determination step of determining a voltage drop of the fuel cell stack at low-temperature startup by low-temperature startup control performed in a case where a temperature of a fuel cell stack configured to generate electric power by reactions between an anode gas and a cathode gas is lower than a low-temperature threshold, or at normal startup by normal startup control performed in a case where the temperature is equal to or higher than the low-temperature threshold; and a voltage recovery control step of performing a voltage recovery control by increasing a cathode gas flow rate in response to the voltage drop of the fuel cell stack at low-temperature startup by the low-temperature startup control or at normal startup by the normal startup control, wherein in the voltage recovery control step, an increase in the cathode gas flow rate in the voltage recovery control during the low-temperature startup until the fuel cell stack reaches a predetermined water-content state is set to be smaller than an increase in the cathode gas flow rate in the voltage recovery control during the normal startup.

According to the present disclosure, the flow rate of the cathode gas increased in the voltage recovery control is set according to the state of the fuel cell stack at startup, that is, according to either the low-temperature startup or the normal startup, and thus the voltage recovery control of the fuel cell stack can be appropriately executed. In particular, since the increase in the cathode gas in the voltage recovery control during the low-temperature startup until the fuel cell stack reaches the predetermined water-content state is set to be smaller than the increase in the cathode gas in the voltage recovery control during the normal startup, the cathode in-plane state of the fuel cell stack at low temperatures can be stabilized. In turn, the present invention contributes to energy efficiency.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic diagram of a fuel cell vehicle in which a fuel cell system according to an embodiment is incorporated;

FIG. 2 is a flowchart provided to describe operations of the embodiment;

FIG. 3A is a detailed flowchart of a process of step S13 in FIG. 2; and FIG. 3B is a detailed flowchart of another process of step S13 in FIG. 2;

FIG. 4 is a timing chart provided to describe operations at normal startup;

FIG. 5 is a timing chart to describe operations at low-temperature startup; and

FIG. 6 is a flowchart provided to describe operations of another embodiment.

### DETAILED DESCRIPTION OF THE INVENTION

### Embodiment

### Configuration

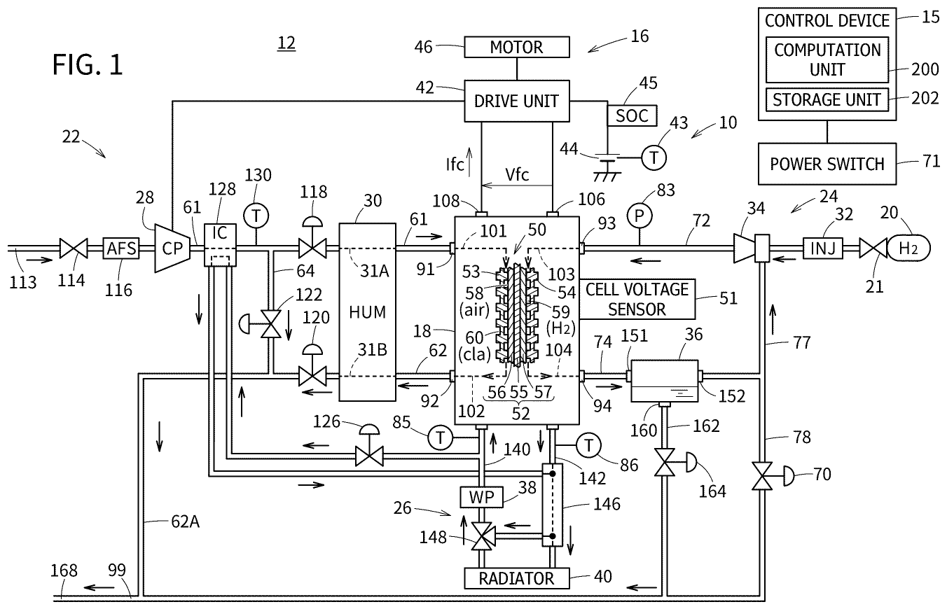

FIG. 1 is a schematic configuration diagram of a fuel cell vehicle 12, into which a fuel cell system 10 according to an embodiment of the present invention is incorporated.

The fuel cell system 10 can be incorporated into any mobile objects, such as automobiles, ships, aircrafts, and robots, other than the fuel cell vehicle 12, and also can be installed in any stationary objects such as houses and the like.

The fuel cell vehicle 12 includes a control device 15 for controlling the entire fuel cell vehicle 12, the fuel cell system 10, and an output unit 16 electrically connected to the fuel cell system 10.

The control device 15 need not necessarily be a single control device, but may be divided into two or more control devices, for example, one used for the fuel cell system 10 and one used for the output unit 16.

The fuel cell system 10 is formed of a fuel cell stack 18, a hydrogen tank 20, an oxygen-containing gas supply device 22, a fuel gas supply device 24, and a medium supply device (heat exchange medium supply device) 26.

The oxygen-containing gas supply device 22 includes a compressor (CP) 28, an intercooler (IC) 128 and a humidifier (HUM) 30.

The fuel gas supply device 24 includes a shut-off valve 21, an injector (INJ) 32, an ejector 34, and a gas-liquid separator 36. The injector 32 may be replaced with a pressure reducing valve. The medium supply device 26 includes a medium pump (WP) 38 and a radiator 40.

The output unit 16 includes a drive unit 42, a high-voltage power storage device (battery) 44, and a motor (electrically powered device) 46. Examples of a load of the drive unit 42 includes not only the motor 46, which is a main device, but also auxiliary devices such as the compressor 28, the medium pump 38, an air conditioner (not shown), and the like. The fuel cell vehicle 12 travels due to a driving force generated by the motor 46.

The auxiliary devices are applied with a high direct current voltage of the power storage device 44 or a low direct current voltage of a low-voltage storage device (not shown). The low-voltage power storage device is charged with low-voltage power obtained by stepping down the high voltage of the power storage device 44 by a step-down converter (not shown).

The state of charge (SOC) of the power storage device 44 is acquired by an SOC sensor 45. The battery temperature That of the power storage device 44 is acquired by a temperature sensor 43.

In the fuel cell stack 18, a plurality of fuel cells (referred to also as power generation cells or unit cells) 50 are stacked. Each of the fuel cells 50 includes a membrane electrode assembly 52, and a pair of separators 53, 54 that sandwich the membrane electrode assembly 52.

Each of the membrane electrode assemblies 52, for example, is equipped with a polymer electrolyte membrane 55 in which a thin film of perfluorosulfonic acid is impregnated with water, and a cathode 56 and an anode 57 sandwiching the polymer electrolyte membrane 55.

On the side of one separator 53 that faces the membrane electrode assembly 52, a cathode side flow field (an oxygen-containing gas flow field) 58 in communication with an oxygen-containing gas supply passage 101 and an oxygen-containing gas discharge passage 102 is formed.

On the side of the other separator 54 that faces the membrane electrode assembly 52, an anode side flow field (a fuel gas flow field) 59 in communication with a fuel gas supply passage 103 and a fuel gas discharge passage 104 is formed.

Fuel (anode) gas (H₂) flows through the anode flow field 59 formed by the anode 57 and the separator 54 stacked on the anode 57.

Oxygen-containing (cathode) gas (air) flows through the cathode flow field 58 formed by the cathode 56 and the separator 53 stacked on the cathode 56.

In the anode 57, by the fuel gas being supplied, hydrogen ions are generated from hydrogen molecules by electrode reactions caused by the electrode catalyst layer, and the hydrogen ions pass through the solid polymer electrolyte membrane 55 and then move to the cathode 56, while electrons are released from hydrogen molecules.

Electrons released from hydrogen molecules move from the negative terminal 106 (FIG. 1) to the positive terminal 108 through the loads such as the drive unit 42, the motor 46, and the like, and then to the cathode 56.

At the cathode 56, by action of the catalyst, the hydrogen ions and the electrons, and oxygen contained in the supplied oxygen-containing gas are reacted to produce water.

Each of the fuel cells 50 of the fuel cell stack 18 is provided with a cell voltage sensor 51 that measures a cell voltage Vcell, which is a voltage between terminals of the fuel cell 50.

The generated power (generated voltage Vfcx generated current Ifc) generated between the positive terminal 108 and the negative terminal 106 is supplied to the motor 46, which is the main device, the compressor 28, which is an auxiliary device, and the like, via the drive unit 42. The generated voltage (stack voltage) Vfc is equal to the sum of the cell voltages Vcell.

The compressor 28 is configured by a mechanical supercharger or the like driven by a compressor motor (not shown) to which electric power of the power storage device 44 is supplied through the drive unit 42. The compressor 28 includes functions such as drawing in and pressurizing external air (the atmosphere, air) from an external air intake port 113, pressurizing the air, and supplying the pressurized air to the fuel cell stack 18 through the humidifier 30.

The intercooler 128 is located downstream of the compressor 28 in an oxygen-containing gas supply flow path 61. The intercooler 128 adjusts the temperature of the oxygen-containing gas (compressed oxygen-containing gas, supercharged gas) fed from the compressor 28. The intercooler 128 cools the oxygen-containing gas fed from the compressor 28. The coolant that has cooled the fuel cell stack 18 flows through the intercooler 128.

If the temperature of the air outside the fuel cell system 10 is at or below the freezing point, the temperature of the coolant guided to the intercooler 128 becomes higher than the temperature of the oxygen-containing gas fed from the compressor 28 to the fuel cell stack 18. The intercooler 128 can increase the temperature of the oxygen-containing gas fed from the compressor 28 if the temperature of the outside air is at or below the freezing point. A temperature sensor 130 for measuring an outlet temperature Tic of the oxygen-containing gas is provided at an outlet of the intercooler 128.

The humidifier 30 has a flow path 31A and a flow path 31B. Air (oxygen-containing gas) compressed, heated to a high temperature and dried by the compressor 28 flows through the flow path 31A. The exhaust gas discharged from the oxygen-containing gas discharge passage 102 of the fuel cell stack 18 flows through the flow path 31B. The humidifier 30 has a function of humidifying the oxygen-containing gas supplied from the compressor 28. That is, the humidifier 30 transfers water contained in the exhaust gas (off-gas) flowing through the flow path 31B to the gas (oxygen-containing gas) flowing through the flow path 31A via an internally provided porous membrane to humidify the gas to be supplied. The humidifier 30 supplies the humidified oxygen-containing gas to the fuel cell stack 18 through an oxygen-containing gas inlet 91.

A shut-off valve 114, an air flow sensor (AFS: flow rate sensor) 116, the compressor 28, the intercooler 128, an input side stop valve 118, and the humidifier 30 are provided on the oxygen-containing gas supply flow path 61 extending from the outside air intake hole 113 to the oxygen-containing gas inlet 91 in this order from the outside air intake hole 113. The flow paths such as the oxygen-containing gas supply flow path 61 drawn by double lines are formed by pipes (the same applies to the following description).

The shut-off valve 114 is opened to allow and close to shut off intake of the air into the oxygen-containing gas supply flow path 61. The air flow sensor 116 measures the mass flow rate of the oxygen-containing gas supplied to the fuel cell stack 18 through the compressor 28. The input side stop valve 118 opens and closes the oxygen-containing gas supply flow path 61.

While the input side stop valve 118 is open, the heated compressed air (cathode gas) from the compressor 28 side is supplied to the cathode flow field 58 of the fuel cell stack 18 via the humidifier 30.

The humidifier 30 and a discharge side stop valve 120 that also functions as a back pressure valve are disposed in this order from anoxygen-containing off-gas outlet 92 on an oxygen-containing off-gas flow path 62 in communication with the oxygen-containing gas discharge passage 102 via the oxygen-containing off-gas outlet 92.

A bypass channel 64 is provided between a suction inlet of the input side stop valve 118 and a discharge outlet of the discharge side stop valve 120 to allow the oxygen-containing gas supply flow path 61 and the oxygen-containing off-gas flow path 62 to communicate with each other while bypassing the fuel cell stack 18. The bypass channel 64 is provided with a bypass valve 122 that opens and closes the bypass channel 64. The bypass valve 122 adjusts the flow rate of the oxygen-containing gas bypassing the fuel cell stack 18. A merging flow path between the bypass channel 64 and the oxygen-containing off-gas flow path 62 communicates with a discharge flow path 62A.

The hydrogen tank 20 is a container including the solenoid shut-off valve 21, compresses highly pure hydrogen under high pressure, and stores the compressed hydrogen.

The fuel gas discharged from the hydrogen tank 20 passes through the shut-off valve 21, the injector 32 and the ejector 34 that are provided in a fuel gas supply flow path 72, and is supplied to an inlet of the anode flow field 59 via a fuel gas inlet 93 and the fuel gas supply passage 103 of the fuel cell stack 18. In the fuel gas supply flow path 72 near the fuel gas inlet 93, a pressure sensor 83 is provided that detects (measures, acquires) an inlet pressure as an anode inlet pressure Pin of the fuel gas in the fuel gas flow field 59.

An outlet of the anode flow field 59 is in communication with an inlet 151 of the gas-liquid separator 36 through the fuel gas discharge passage 104, a fuel off-gas outlet 94, and a fuel off-gas flow path 74, and further, the fuel off-gas, which is a hydrogen containing gas, is supplied to the gas-liquid separator 36 from the anode flow field 59.

The gas-liquid separator 36 separates the fuel off-gas into gaseous components and liquid components (water). The gaseous components of the fuel off-gas (fuel exhaust gas) are discharged from a gas discharge hole 152 of the gas-liquid separator 36 and supplied to an intake of the ejector 34 through a circulation flow path 77 while a purge valve 70 is in a closed state.

On the other hand, when the purge valve 70 is opened, the fuel-off gas is mixed with the exhaust gas discharged from the discharge flow path 62A via a purge flow path 78, and is discharged to the outside (atmosphere) through a discharge flow path 99 and a discharge gas exhaust hole 168.

The liquid components of the fuel off-gas are discharged from a liquid discharge hole 160 of the gas-liquid separator 36 to a drain flow path 162 in which a drain valve 164 is provided, mixed with the discharged gas that is discharged from the discharge flow path 62A, and discharged to the outside (air) through the discharge flow path 99 and the discharge gas exhaust hole 168.

As described above, the fuel gas within the liquid water and the fuel off-gas discharged from the drain flow path 162 or the purge flow path 78 is diluted in the discharge flow path 99, due to the oxygen-containing off-gas from the discharge flow path 62A, and is discharged from the discharge gas exhaust port 168 to the exterior (into the atmosphere) of the fuel cell vehicle 12.

The medium supply device 26 of the fuel cell system 10 includes a medium supply flow path 140 and a medium discharge flow path 142, for allowing a heat exchange medium to flow therethrough.

The heat exchange medium is supplied through the medium supply flow path 140 to a medium flow field 60 inside the fuel cell stack 18, and the heat exchange medium that has flowed through the medium flow field 60 of the fuel cell stack 18 is discharged to the medium discharge flow path 142.

The medium discharge flow path 142 communicates with the radiator 40 and a first input valve of a three way valve 148 through a flow path inside the heater 146, and communicates with a second input valve of the three way valve 148 through the radiator 40. The radiator 40 cools the heat exchange medium.

An output valve of the three way valve 148 communicates with the medium supply flow path 140. The medium supply flow path 140 is provided with the medium pump 38. The medium pump 38 causes the heat exchange medium to circulate inside a medium circulation circuit.

The medium supply flow path 140 communicates with a coolant inlet of the intercooler 128 through an intercooler valve 126. The coolant outlet of the intercooler 128 communicates with the medium discharge flow path 142 through the flow path inside the heater 146.

Temperature sensors (temperature acquisition units) 85, 86 are respectively provided in the medium supply flow path 140 and the medium discharge flow path 142. The temperature of the heat exchange medium (coolant temperature, medium outlet temperature) Tco detected by the temperature sensor 86 is regarded as the (internal) temperature of the fuel cell stack 18.

### Description of Control Device 15

All the constituent elements including the actuators such as the compressor 28, the injector 32, and the electrically powered pump (medium pump) 38 of the fuel cell system 10 and the like are integrally controlled by the control device 15.

The input-side stop valve 118, the discharge side stop valve 120, the purge valve 70, and the drain valve 164, and the bypass valve 122, except for the shut-off valves 21, 114 which are on-off valves whose opening and closing are controlled by the control device 15, are flow rate adjustment valves the valve openings of which are controlled by the control device 15, the duty thereof may also be controlled using electromagnetic control type ON/OFF valves.

The control device 15 is an electronic device (computer) provided in the fuel cell system 10. The control device 15 includes a computation unit (processing unit) 200, a storage unit 202, a display unit, and an operation unit.

The computation unit 200 may be constituted by a processor such as a CPU (Central Processing Unit), a GPU (Graphics Processing Unit), or the like. More specifically, the computation unit can be configured by a processing circuit (processing circuitry).

The computation unit 200 comprises a determination unit and a control unit. The determination unit and the control unit can be realized by programs, which are stored in the storage unit 202, being executed by the computation unit 200.

Moreover, it should be noted that at least a portion of the determination unit and the control unit may be implemented by an integrated circuit such as an ASIC (Application Specific Integrated Circuit), or a FPGA (Field-Programmable Gate Array). Further, at least a portion of the determination unit and the control unit may be constituted by an electronic circuit including a discrete device.

The storage unit 202 may be made up of a volatile memory (not shown), and a non-volatile memory (not shown). Examples of the volatile memory includes a RAM (Random Access Memory), etc. Such a volatile memory is used as a working memory of the processor, and temporarily stores data necessary for performing processing or calculations. Examples of the non-volatile memory includes a ROM (Read only memory), a flash memory, etc. The non-volatile memory is used as a storage memory, and serves to store a program, a table, a map, and the like. At least part of the storage unit 202 may be provided in the processor, the integrated circuit, etc. as described above.

The computation unit 200 of the control device 15, by executing calculations in accordance with the program, performs controls such as a control of operations of the fuel cell vehicle 12 and the fuel cell system 10.

### Operation

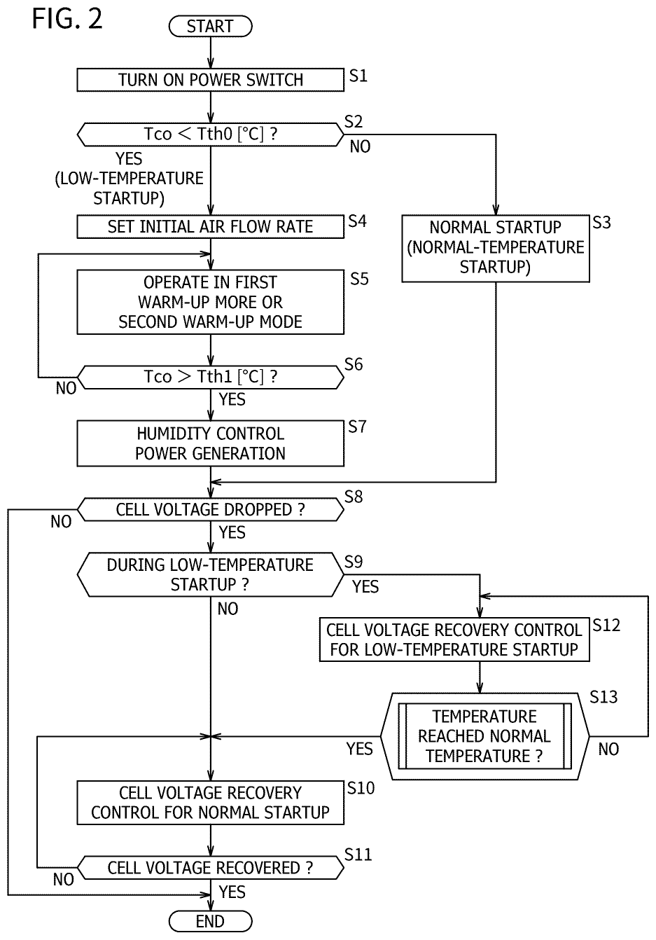

Next, operation of the above-described embodiment, basically having the above structure will be described in detail based on a flow chart shown in FIG. 2.

In the present disclosure, a method of setting the amount of increase in the flow rate of cathode gas (referred to as air flow rate) in the cell voltage recovery control at startup is clarified, and thus the following description will be made focusing on the air flow rate.

In step S1, when the computation unit 200 of the control device 15 determines affirmatively that startup has begun because a power switch 71 has been turned from the OFF state to the ON state, the process advances to step S2. In the following description, the computation unit 200 of the control device 15 will be described as the control device 15.

In step S2, the control device 15 determines whether the fuel cell stack is being started up at a low temperature (low-temperature startup) or at a normal temperature (normal-temperature startup).

In this case, if the temperature Tco of the heat exchange medium detected by the temperature sensor 86 is lower than the low-temperature threshold (low-temperature determination reference) Tth0 (S2: YES), the control device 15 determines that the startup is the low-temperature startup and advances the process to step S4, and if the temperature Tco is equal to or higher than the low-temperature threshold Tth0 (S2: NO), the control device 15 determines that the startup is the normal startup (normal-temperature startup) and advances the process to step S3.

The low-temperature threshold Tth0 may be any temperature within the temperature range (e.g., 0° C. to 120° C.) during power generation of the fuel cell stack 18 as long as operations at a low temperature is determined with the threshold, and may be set to, for example, a temperature below the freezing point or at 0° C., but is not limited thereto, and may be set to a temperature suitable for the fuel cell system 10 and the fuel cell vehicle 12.

In this embodiment, the startup at a temperature lower than the low-temperature threshold Tth0 is referred to as the low-temperature startup (low-temperature startup control), and the startup at a temperature equal to or higher than the low-temperature threshold Tth0 is referred to as the normal startup (normal startup control). The startup at a temperature equal to or higher than the low-temperature threshold Tth0 is also referred to as a normal-temperature startup.

In the case of the normal startup (S2: NO), in step S3, the control device 15 activates the compressor 28, sets the air flow rate to the initial air flow rate Sp1, starts power generation in the normal startup, and advances the process to step S8.

On the other hand, in the case of the low-temperature startup (S2: YES), in step S4, the control device 15 activates the compressor 28, sets the air flow rate to the initial flow rate Sp1, operates the fuel cell stack 18 to perform power generation for a predetermined time (initial power generation), and advances the process to step S5.

In step S5, the control device 15 operates the fuel cell stack 18 in a first warm-up mode in which the fuel cell stack 18 is caused to generate power at a first output [kW] or in a second warm-up mode in which the fuel cell stack 18 is caused to generate power at a second output [kW] higher than the first output (first output<second output), according to the battery temperature Tbat [° C.] of the power storage device 44 acquired by the temperature sensor 43 and the SOC [%] of the power storage device 44 acquired by the SOC sensor 45, and advances the process to step S6. In the first and second warm-up modes (warm-up power generation, warm-up control) in step S5, the air flow rate is set to a warm-up air flow rate Sp3 that is smaller than the initial air flow rate Sp1 (Sp3<Sp1).

Although the battery capacity [kWh] is smaller than that at normal temperature since the fuel cell stack 18 is started up at a low temperature, if the SOC is relatively small in this state, the fuel cell stack 18 is operated in the second warm-up mode because the margin for charging (chargeable amount) is large, and if the SOC is relatively large, the fuel cell stack 18 is operated in the first warm-up mode because the margin for charging is small.

In step S6, the control device 15 determines whether or not the medium outlet temperature Tco of the heat-exchange medium detected by the temperature sensor 86 has risen to a temperature exceeding a first temperature reference value Tth1 for determining warm-up completion, repeats steps S5 and S6 until the determination becomes positive, and advances the process to step S7 upon a positive determination (S6: YES).

The first temperature reference value Tth1 for determining warm-up completion may be any predetermined value within the temperature range (e.g., 0° C. to 120° C.) during power generation of the fuel cell stack 18 as long as the predetermined value is larger than the low-temperature threshold Tth0.

In step S7, the control device 15 starts humidity control power generation, and advances the process to step S8 after terminating the humidity control power generation. In the humidity control power generation, the humidity of the fuel cell stack 18 that has increased during the first and second warm-up modes at the low-temperature startup is reduced.

Specifically, the input side stop valve 118 is opened to continue power generation for a predetermined time (humidity control time) by supplying the oxygen-containing gas to the fuel cell stack 18 at an air flow rate Sp2 obtained by increasing the initial air flow rate Sp1 by a predetermined additional air flow rate ΔSpa. The air flow rate Sp2 is larger than the warm-up air flow rate Sp3. The predetermined time (humidity control time) is set to be longer as the medium outlet temperature Tco at startup is lower. This humidity control power generation can eliminate the over-humidified state inside the power generation cells 50. The completion of the humidity control power generation may be determined based on an elapsed time, or based on whether the temperature of the fuel cell system 10 exceeds a reference temperature for determining warm-up completion or a predetermined reference temperature for determining humidity control completion set separately from the reference temperature for determining warm-up completion.

In step S8, the control device 15 determines whether or not the cell voltage Vcell is decreased at startup (voltage drop determination step).

The control device 15 determines whether the cell voltage Vcell has decreased based on whether a difference ΔV (ΔV=Vcellmean−Vcellmin), which is obtained by subtracting the minimum cell voltage Vcellmin from the average voltage Vcellmean of the cell voltage Vcell, exceeds an activation determination threshold ΔVtha (ΔV>ΔVtha).

In the case of a negative determination (S8: NO, ΔV≤ΔVtha) that the cell voltage Vcell has not decreased, the humidity control power generation is stopped, and the startup process is terminated, and thereafter, a power generation (normal power generation) operation according to the power required by the fuel cell vehicle 12 is executed.

On the other hand, in the case of a positive determination (S8: YES, ΔV>ΔVtha) that the cell voltage Vcell has decreased, the startup process (the cell voltage recovery control for low-temperature startup) is continued, and advances the process to step S9.

In step S9, the control device 15 determines whether the decrease in the cell voltage Vcell occurs at the low-temperature startup (step S2: YES) or not (step S2: NO; at the normal startup in step S3).

The control device 15 advances the process to step S10 if the low-temperature startup has not been performed (S9: NO), and advances the process to step S12 if the low-temperature startup has been performed (S9: YES).

In step S10, the control device 15 performs the cell voltage recovery control for normal startup. That is, the control device 15 sets the air flow rate to the air flow rate Sp2 (Sp2=Sp1+ΔSpa) obtained by increasing the initial air flow rate Sp1 by the predetermined additional air flow rate ΔSpa. In this case, the rotational speed of the compressor 28 is increased by the additional air flow rate ΔSpa, whereupon the process is advanced to step S11.

In step S11, the control device 15 determines whether or not the decrease in the cell voltage Vcell is eliminated and the cell voltage Vcell is recovered. When the cell voltage is not recovered (S11: NO), the control device 15 continues the cell voltage recovery control with the air flow rate for the normal startup in step S10.

In the cell recovery determination in step S11, the control device 15 determines whether the cell voltage Vcell has been recovered, based on whether a difference ΔV (ΔV=Vcellmean−Vcellmin) obtained by subtracting the minimum cell voltage Vcellmin from the average voltage Vcellmean of the cell voltage Vcell is less than a deactivation determination threshold ΔVthb (ΔV<ΔVthb).

Here, the deactivation determination threshold ΔVthb is set to be smaller than the activation determination threshold ΔVtha (ΔVthb<ΔVtha) to provide hysteresis. Thus, the occurrence of hunting in the control is suppressed.

After the cell voltage Vcell is recovered (S11: YES), the control device 15 terminates the startup process, and thereafter, performs the power generation (normal power generation) according to the power required by the fuel cell vehicle 12.

On the other hand, in the determination in step S9 described above, if the control device 15 determines that the low-temperature startup is being performed (S9: YES), the control device 15 advances the process to step S12.

In step S12, the control device 15 performs the cell voltage recovery control for low-temperature startup. In the cell voltage recovery control for low-temperature startup, the air flow rate is set to the air flow rate Sp2′ (Sp2′=Sp1+ΔSpb) for the humidity control power generation obtained by increasing the initial air flow rate Sp1 by the predetermined additional air flow rate ΔSpb. In this case, the rotational speed of the compressor 28 is increased by the additional air flow rate ΔSpb, whereupon the process is advanced to step S13. In the humidity control power generation, dry cathode gas from the compressor 28 via the intercooler 128 may be supplied to the fuel cell stack 18 while bypassing the humidifier 30.

The additional air flow rate ΔSpb in the cell voltage recovery control at low-temperature startup is set to a value smaller than the additional air flow rate ΔSpa in the cell voltage recovery control at normal-temperature startup (ΔSpb<ΔSpa). In this way, the additional air flow rate for the cell voltage recovery control is set according to the state of the fuel cell stack 18 at startup, that is, whether the low-temperature startup or the normal startup (additional air flow rate at low-temperature startup ΔSpb<additional air flow rate at normal-temperature startup ΔSpa), so the cell voltage recovery control of the fuel cell stack 18 can be performed appropriately. The cell voltage recovery control after the low-temperature startup of the step S12 will be described in more detail including the background thereof.

In either case of the normal-temperature startup or the low-temperature startup, when the cell voltage Vcell of the fuel cell stack 18 decreases, the flow rate of air (the cathode gas) supplied to the fuel cell stack 18 is increased to facilitate drainage in the cathode flow field 58, thereby recovering the cell voltage Vcell.

However, particularly after the low-temperature startup, there is a case in which the power generation continues at a decreased cell voltage Vcell. Although the cell voltage recovery control described above is executed also in this case, if the air flow rate is changed after the cell voltage Vcell has decreased at the low-temperature startup, the in-plane state of the fuel cell stack 18 is not stable, which may cause an adverse effect, and the cell voltage Vcell may further decrease.

In this embodiment, at the low-temperature startup (S9: YES), the additional air flow rate ΔSpb for the low-temperature startup (predetermined increase in the cathode gas flow rate for voltage recovery) that is smaller than the additional air flow rate ΔSpa for the normal-temperature startup is set (S12), and thus the recovery control of the cell voltage Vcell can be appropriately performed. After the low-temperature startup, the air flow rate may be set to be small from the beginning until the normal state is reached.

The cause of the decrease in the cell voltage Vcell lies not only on the cathode 56 side but also on the anode 57 side. For example, when decease in the hydrogen concentration on the anode flow path 59 side due to excessive nitrogen is detected by a hydrogen concentration meter (not shown), a process of increasing the anode gas and performing nitrogen purge may be executed.

Returning to the flowchart, the subroutine of step S13 defines the process of determining whether or not the medium outlet temperature Tco has reached to a normal temperature.

In step S13, the control device 15 performs a process of determining whether or not the medium outlet temperature Tco of the fuel cell stack 18 has reached to a normal temperature, and if the medium outlet temperature Tco has not reached (S13: NO), the control device 15 continues the cell voltage recovery control for low-temperature startup in step S12 until the medium outlet temperature Tco has reached, and if the medium outlet temperature Tco has reached (S13: YES), the control device 15 advances the process to step S10.

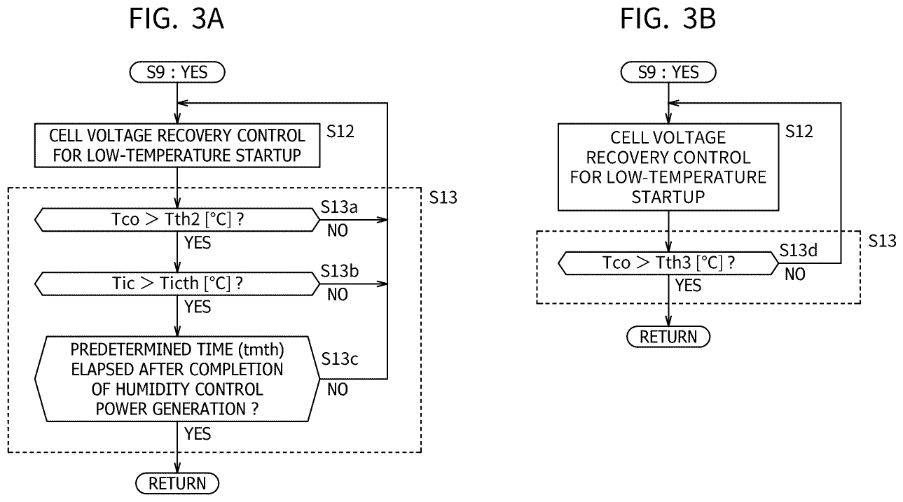

FIGS. 3A and 3B are detailed flowcharts showing determination processes of step S13 as to whether or not the temperature has reached a normal temperature.

Regarding the process in FIG. 3A, in step S13a of FIG. 3A, the control device 15 determines if the medium outlet temperature Tco has increased to exceed a second temperature reference value Tth2 for determining warm-up completion, and if not (S13a: NO), continues the cell voltage recovery control for low-temperature startup in step S12, and if so (S13a: YES), advances the process to step S13b. The second temperature reference value Tth2 for determining warm-up completion is set to a temperature equal to or higher than the first temperature reference value Tth1 for determining warm-up completion (Tth2≥Tth1).

In step S13b, the control device 15 determines whether or not an outlet temperature Tic of the intercooler 128 exceeds a temperature threshold Ticth [° C.], and if not (S13b: NO), continues the cell voltage recovery control for low-temperature startup in step S12, and if so (S13b: YES), advances the process to step S13c.

In step S13c, the control device 15 determines whether or not a predetermined time tmth has elapsed after the completion of the humidity control power generation, and if not (S13c: NO), continues the cell voltage recovery control for low-temperature startup in step S12, and if so (S13c: YES), determines that the outlet temperature Tco has been reached a normal temperature, and advances the process to the cell voltage recovery control for normal startup in step S10. The time at which the count is started to determine whether the predetermined time tmth has elapsed may be any of the time when the fuel cell temperature reaches the first temperature reference value Tth1 for determining warm-up completion, the time when the fuel cell temperature reaches the second temperature reference value Tth2 for determining warm-up completion, and the time when the humidity control power generation is completed.

Regarding the process in FIG. 3B, in step S13d of FIG. 3B, the control device 15 determines if the medium outlet temperature Tco has increased to exceed a third temperature reference value Tth3 for determining warm-up completion that is higher than the second temperature reference value Tth2 for determining warm-up completion, and if not (S13d: NO), continues the cell voltage recovery control for low-temperature startup in step S12, and if so (S13d: YES), advances the process to the cell voltage recovery control got normal startup in step S10.

Although the determination in steps S13a to S13c is a logical product, the determination may be a logical sum, and the process may advance to step S10 when any one of the determinations is affirmative. At least one of the second temperature reference Tth2 for determining warm-up completion, the predetermined time tmth, and the third temperature reference Tth3 for determining warm-up completion may have values corresponding to the first warm-up mode and the second warm-up mode. In this case, at least one of the second temperature reference Tth2 for determining warm-up completion, the predetermined time tmth, and the third temperature reference value Tth3 for determining warm-up completion may be larger in values in the second warm-up mode than those in the first warm-up mode, or conversely, may be larger in values in the first warm-up mode than those in the second warm-up mode.

As described above, in step S10, the control device 15 performs the cell voltage recovery control for normal startup. That is, the control device 15 sets the air flow rate to the air flow rate Sp2 (Sp2=Sp1+ΔSpa) obtained by increasing the initial air flow rate Sp1 by the predetermined additional air flow rate Δspa to increase the rotational speed of the compressor 28, whereupon the process is advanced to step S11.

In step S11, the control device 15 determines whether or not the decrease in the cell voltage Vcell is eliminated and the cell voltage Vcell is recovered. When the cell voltage is not recovered (S11: NO), the cell voltage recovery control with the air flow rate for the normal startup in step S10 is continued.

In step S11, the control device 15 determines whether the cell voltage Vcell has been recovered, based on whether a difference ΔV (ΔV=Vcellmean−Vcellmin) obtained by subtracting the minimum cell voltage Vcellmin from the average voltage Vcellmean of the cell voltage Vcell is less than a deactivation determination threshold ΔVthb (ΔV<ΔVthb).

Here, the deactivation determination threshold ΔVthb is set to be smaller than the activation determination threshold ΔVtha (ΔVthb<ΔVtha) to provide hysteresis. Thus, the occurrence of hunting in the control is suppressed.

After the cell voltage Vcell is recovered (S11: YES), the startup process is terminated, and thereafter, the power generation according to the power required by the fuel cell vehicle 12 is executed.

### Explanation Using Timing Chart

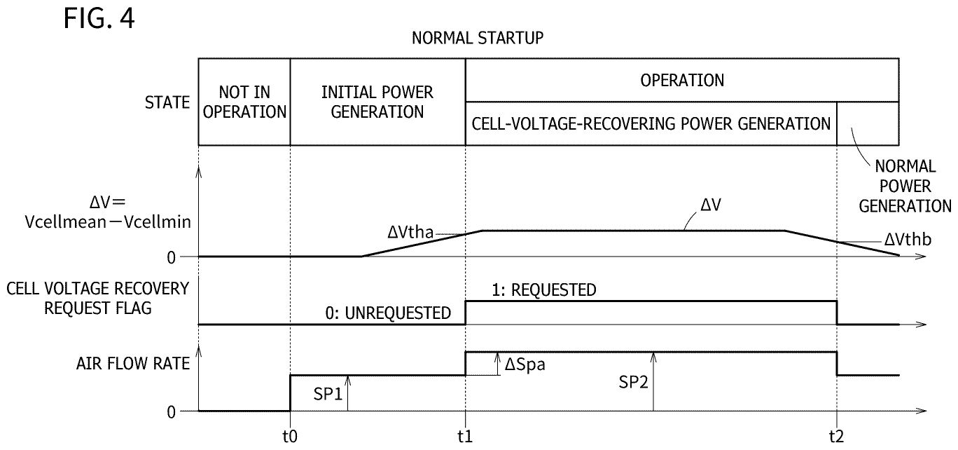

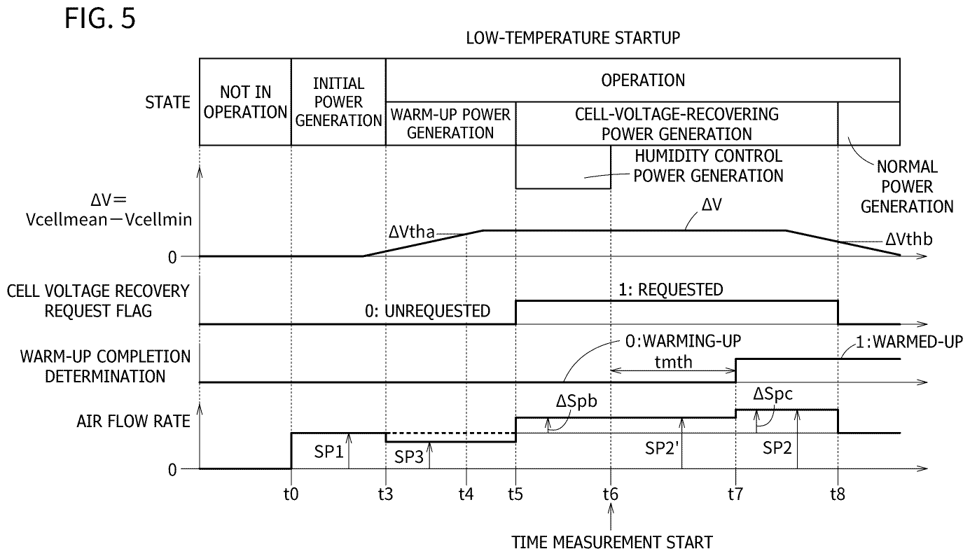

An example of the operation described with reference to the flowchart of FIG. 2 will be described with reference to the timing charts of FIGS. 4 and 5. In the following description, some step numbers in the flowchart of FIG. 2 are inserted for the sake of convenience of understanding.

FIG. 4 shows a timing chart of the normal temperature startup, and FIG. 5 shows a timing chart of the low-temperature startup.

### Normal Temperature Startup

When the power switch 71 is switched from the OFF state to the ON state at time to in FIG. 4, the startup process of the fuel cell system 10 is initiated (power generation is started) with the initial air flow rate Sp1 (S3) through the determination in step S2 (S2: NO).

At time t1 when the difference ΔV obtained by subtracting a minimum cell voltage Vcellmin of the cell voltages Vcell from an average voltage Vcellmean of the cell voltages Vcell detected by the cell voltage sensor 51 at the normal-temperature startup exceeds the activation determination threshold ΔVtha (S8: YES), a cell voltage recovery request flag is set to 1 (requested). The larger the difference ΔV is, the lower the minimum cell voltage Vcellmin is.

After time t1, the cell-voltage-recovering power generation process (S10, S11) is performed with the air flow rate Sp2 (Sp2=Sp1+ΔSpa) obtained by increasing the air flow rate by the additional air flow rate ΔSpa.

At time t2, when the difference ΔV falls below ΔVthb (ΔVthb<ΔVtha) (S11: YES), the cell voltage recovery request flag is set to 0 (unrequested), the normal startup control related to the cell-voltage-recovering power generation is terminated, and the normal power generation is executed.

### Low-Temperature Startup

When the power switch 71 is switched from the OFF state to the ON state at time to in FIG. 5, the startup process of the fuel cell system 10 is initiated (power generation is started) with the initial air flow rate Sp1 (S4) through the determination in step S2 (S2: YES).

In the case of the low-temperature startup, the air flow rate is reduced from the initial air flow rate Sp1 to the warm-up air flow rate Sp3 at time t3, and warm-up power generation in the first warm-up mode or the second warm-up mode is performed (S5). The warm-up power generation reduces the mean voltage Vcellmean, and the temperature can be raised quickly by using, as additional heat generation, the heat that is not used for power generation.

When the medium outlet temperature Tco exceeds the first temperature-threshold value Tth1 for determining warm-up completion (time t5, S6: YES), the humidity control power generation (S7) is started in which dry cathode gas is supplied to the fuel cell stack 18 while bypassing the humidifier 30.

At time t5, it is determined whether the cell voltage Vcell is decreased, and since it is determined that the cell voltage Vcell has decreased at time t4 in the illustrated case, the air flow rate is increased from the warm-up air flow rate Sp3 to the air flow rate Sp2′.

The air flow rate Sp2′ is set to the additional air flow rate ΔSpb that is smaller than the additional air flow rate ΔSpa at the normal-temperature startup (Sp2′=Sp1+ΔSpb).

When the time period measured from the end of the humidity control power generation at time t6 reaches the predetermined time tmth at time t7, it is determined that the warm-up is completed.

After time t7, the air flow rate is increased to the air flow rate Sp2 (increased by an additional air flow rate ΔSpc from the initial air flow rate Sp1), the cell voltage recovery control is continued, and when the difference ΔV falls below the deactivation determination threshold ΔVthb (S11: YES) at time t8, the cell voltage recovery request flag is set to 0, the cell-voltage-recovering power generation is ended, and the normal power generation is performed. The additional air flow rate ΔSpc is set to be substantially equal to the additional air flow rate ΔSpa (see FIG. 4).

The above-described embodiment can be modified in the following manner.

### Modifications

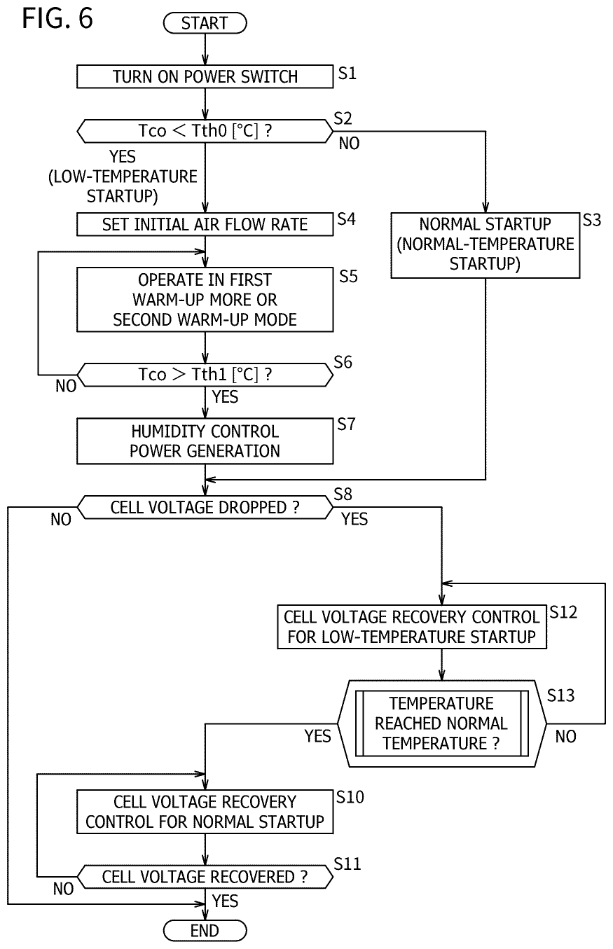

FIG. 6 is a flowchart according to a modification. The same step numbers are assigned to the same processes as those in the flowchart of FIG. 2, and only different portions will be described.

In the flowchart of FIG. 6, when the cell voltage Vcell is determined to have decreased in step S8 (S8: YES), the cell voltage recovery control for low-temperature startup is performed without determining whether or not the low-temperature startup has been performed (S9 in FIG. 2). This control enables the cell voltage recovery control of the fuel cell stack to be appropriately executed. In turn, the present invention contributes to energy efficiency.

### Supplementary Note

In relation to the above-described disclosure, the following supplementary notes are further disclosed.

### Supplementary Note 1

The fuel cell system (10) of the present disclosure including the fuel cell stack (18) configured to generate electric power by reactions between an anode gas and a cathode gas, wherein the fuel cell system performs a low-temperature startup control in the case where a temperature (Tco) of the fuel cell stack is lower than the low-temperature threshold (Tth0), performs the normal startup control in the case where the temperature is equal to or higher than the low-temperature threshold, and performs the voltage recovery control of the fuel cell stack by increasing the cathode gas flow rate in response to a voltage drop of the fuel cell stack at the low-temperature startup by the low-temperature startup control or at normal startup by the normal startup control, and wherein the increase in the cathode gas flow rate until the fuel cell stack reaches the predetermined water-content state (ΔSpb) in the voltage recovery control during the low-temperature startup is set to be smaller than the increase in the cathode gas flow rate in the voltage recovery control during the normal startup (ΔSpa).

In this manner, the amount of increase in the cathode gas in the voltage recovery control is set according to the state of the fuel cell stack at startup, that is, according to either the low-temperature startup or the normal startup, and thus the voltage recovery control of the fuel cell stack can be appropriately executed.

In particular, since the increase in the cathode gas until the fuel cell stack reaches the predetermined water-content state in the voltage recovery control during the low-temperature startup is set to be smaller than the increase in the cathode gas in the voltage recovery control during the normal startup, the cathode in-plane state of the fuel cell stack at low temperatures can be stabilized.

### Supplementary Note 2

The fuel cell system of the present disclosure including the fuel cell stack configured to generate electric power by reactions between an anode gas and a cathode gas, wherein the fuel cell system performs the low-temperature startup control in the case where a temperature of the fuel cell stack is lower than the low-temperature threshold, performs the normal startup control in the case where the temperature is equal to or higher than the low-temperature threshold, and performs the voltage recovery control of the fuel cell stack by increasing a cathode gas flow rate in response to a voltage drop of the fuel cell stack after the low-temperature startup by the low-temperature startup control or after normal startup by the normal startup control, wherein the increase in the cathode gas flow rate until the fuel cell stack reaches a predetermined water-content state (ΔSpb) in the voltage recovery control during the low-temperature startup is set to be smaller than the increase in the cathode gas flow rate after the fuel cell stack has reached the predetermined water-content state (ΔSpc) in the voltage recovery control during the low-temperature startup.

In this manner, the voltage recovery control of the fuel cell stack can be appropriately executed based on the state of the fuel cell stack at the low-temperature startup.

### Supplementary Note 3

In the fuel cell system according to Supplementary Note 1 or 2, warm-up control (S5, time t3 to time t5) of the fuel cell stack may be executed during the low-temperature startup, and it may be determined that the fuel cell stack has reached the predetermined water-content state when a predetermined time (tmth) has elapsed from the time (t6) at which the fuel cell temperature reaches the temperature reference value (Tth2) for determining completion of warm-up control or when the fuel cell temperature reaches the temperature reference value (Tth3) for determining a normal temperature that is higher than the temperature reference value for determining completion of warm-up control.

In this manner, the voltage recovery control of the fuel cell stack can be appropriately executed based on whether the fuel cell stack has become the predetermined water-content state at the low-temperature startup.

### Supplementary Note 4

In the fuel cell system according to Supplementary Note 1 or 2, warm-up control of the fuel cell stack may be executed at the low-temperature startup, and after the warm-up control, humidity control power generation may be executed by the fuel cell stack by supplying more cathode gas to the fuel cell stack than in the warm-up control, and it may be determined that the fuel cell stack has reached the predetermined water-content state when the predetermined time has elapsed from completion of the humidity control power generation.

### Supplementary Note 5

In the fuel cell system according to Supplementary Note 3, the warm-up control may include the first warm-up mode in which the fuel cell stack is operated at the first output and the second warm-up mode in which the fuel cell stack is operated at the second output higher than the first output, and at least one of the temperature reference value (Tth2) for determining warm-up completion, the predetermined time (tmth), and the temperature reference value (Tth3) for determining normal temperature may have values corresponding to the first warm-up mode and the second warm-up mode, respectively.

In this manner, the voltage recovery control of the fuel cell stack can be appropriately executed based on the output of the fuel cell stack during execution of the warm-up control.

### Supplementary Note 6

In the fuel cell system according to Supplementary Note 5, the at least one of the temperature reference value for determining warm-up completion, the predetermined time, and the temperature reference value for determining normal temperature may have the values in which a value corresponding to the second warm-up mode is greater than a value corresponding to the first warm-up mode.

In this manner, the voltage recovery control of the fuel cell stack can be appropriately executed based on the output of the fuel cell stack during execution of the warm-up control.

### Supplementary Note 7

The fuel cell system according to Supplementary Note 5 may further include the power storage device (44) configured to be charged with power output from the fuel cell stack, wherein the first output and the second output are target power output from the fuel cell stack, and the first warm-up mode and the second warm-up mode may be switched based on a state of charge (SOC) of the power storage device.

In this manner, the voltage recovery control of the fuel cell stack can be appropriately executed based on the power output from the fuel cell stack during execution of the warm-up control.

### Supplementary Note 8

The control method of the fuel cell system according to the present disclosure, including: the voltage drop determination step of determining a voltage drop of the fuel cell stack at low-temperature startup by low-temperature startup control performed in the case where a temperature of the fuel cell stack configured to generate electric power by reactions between an anode gas and a cathode gas is lower than a low-temperature threshold, or at normal startup by normal startup control performed in the case where the temperature is equal to or higher than the low-temperature threshold; and the voltage recovery control step of performing a voltage recovery control by increasing the cathode gas flow rate in response to the voltage drop of the fuel cell stack at low-temperature startup by the low-temperature startup control or at normal startup by the normal startup control, wherein in the voltage recovery control step, an increase in the cathode gas flow rate until the fuel cell stack reaches the predetermined water-content state in the voltage recovery control during the low-temperature startup is smaller than an increase in the cathode gas flow rate in the voltage recovery control during the normal startup.

In this manner, the amount of increase in the cathode gas in the voltage recovery control is set according to the state of the fuel cell stack at startup, that is, according to either the low-temperature startup or the normal startup, and thus the voltage recovery control of the fuel cell stack can be appropriately executed at low temperature.

The present disclosure is not necessarily limited to the individual embodiments described above. These embodiments can be subjected to various additions, substitutions, modifications, partial deletions and the like, within a range that does not depart from the essence and gist of the present disclosure, or alternatively, the spirit and gist of the present disclosure as derived from the contents described in the claims and their equivalents. Further, these embodiments can also be implemented in combination. For example, in the above-described embodiments, the order of each of the operations and the order of each of the processes are illustrated as examples, and the present invention is not necessarily limited to these features. The same applies also in the case that numerical values or mathematical expressions are used in the description of the aforementioned embodiments.

1. A fuel cell system including a fuel cell stack configured to generate electric power by reactions between an anode gas and a cathode gas, wherein the fuel cell system performs a low-temperature startup control in a case where a temperature of the fuel cell stack is lower than a low-temperature threshold, performs a normal startup control in a case where the temperature is equal to or higher than the low-temperature threshold, and performs a voltage recovery control of the fuel cell stack by increasing a cathode gas flow rate in response to a voltage drop of the fuel cell stack after the low-temperature startup by the low-temperature startup control or after normal startup by the normal startup control, wherein
one or more processors that execute computer-executable instructions stored in a memory,
wherein the one or more processors execute the computer-executable instructions to cause the fuel cell system to:
set an increase in the cathode gas flow rate until the fuel cell stack reaches a predetermined water-content state in the voltage recovery control during the low-temperature startup to be smaller than an increase in the cathode gas flow rate in the voltage recovery control during the normal startup.

2. A fuel cell system including a fuel cell stack configured to generate electric power by reactions between an anode gas and a cathode gas, wherein the fuel cell system performs a low-temperature startup control in a case where a temperature of the fuel cell stack is lower than a low-temperature threshold, performs a normal startup control in a case where the temperature is equal to or higher than the low-temperature threshold, and performs a voltage recovery control of the fuel cell stack by increasing a cathode gas flow rate in response to a voltage drop of the fuel cell stack after the low-temperature startup by the low-temperature startup control or after normal startup by the normal startup control, wherein
one or more processors that execute computer-executable instructions stored in a memory,
wherein the one or more processors execute the computer-executable instructions to cause the fuel cell system to:
set an increase in the cathode gas flow rate until the fuel cell stack reaches a predetermined water-content state in the voltage recovery control during the low-temperature startup to be smaller than an increase in the cathode gas flow rate after the fuel cell stack has reached the predetermined water-content state in the voltage recovery control during the low-temperature startup.

3. The fuel cell system according to claim 1, wherein
the one or more processors execute the computer-executable instructions to cause the fuel cell system to:
execute warm-up control of the fuel cell stack during the low-temperature startup, and
in a case where a predetermined time has elapsed from a time at which the fuel cell temperature reaches a temperature reference value for determining completion of warm-up control, or in a case where the fuel cell temperature reaches a temperature reference value for determining a normal temperature that is higher than the temperature reference value for determining completion of warm-up control, determine that the fuel cell stack has reached a predetermined water-content state.

4. The fuel cell system according to claim 2, wherein
the one or more processors execute the computer-executable instructions to cause the fuel cell system to:
execute warm-up control of the fuel cell stack during the low-temperature startup, and
in a case where a predetermined time has elapsed from a time at which the fuel cell temperature reaches a temperature reference value for determining completion of warm-up control, or in a case where the fuel cell temperature reaches a temperature reference value for determining a normal temperature that is higher than the temperature reference value for determining completion of warm-up control, determine that the fuel cell stack has reached a predetermined water-content state.

5. The fuel cell system according to claim 1, wherein
the one or more processors execute the computer-executable instructions to cause the fuel cell system to:
execute warm-up control of the fuel cell stack during the low-temperature startup, and
after the warm-up control, execute humidity control power generation by the fuel cell stack by supplying more cathode gas to the fuel cell stack than in the warm-up control, and
determine that the fuel cell stack has reached the predetermined water-content state in a case where a predetermined time has elapsed from completion of the humidity control power generation.

6. The fuel cell system according to claim 2, wherein
the one or more processors execute the computer-executable instructions to cause the fuel cell system to:
execute warm-up control of the fuel cell stack during the low-temperature startup,
after the warm-up control, execute humidity control power generation by the fuel cell stack by supplying more cathode gas to the fuel cell stack than in the warm-up control, and
determine that the fuel cell stack has reached the predetermined water-content state in a case where a predetermined time has elapsed from completion of the humidity control power generation.

7. The fuel cell system according to claim 3, wherein
the warm-up control includes a first warm-up mode in which the fuel cell stack is operated at a first output and a second warm-up mode in which the fuel cell stack is operated at a second output higher than the first output, and
at least one of the temperature reference value for determining warm-up completion, the predetermined time, and the temperature reference value for determining normal temperature includes values corresponding to the first warm-up mode and the second warm-up mode, respectively.

8. The fuel cell system according to claim 4, wherein
the warm-up control includes a first warm-up mode in which the fuel cell stack is operated at a first output and a second warm-up mode in which the fuel cell stack is operated at a second output higher than the first output, and
at least one of the temperature reference value for determining warm-up completion, the predetermined time, and the temperature reference value for determining normal temperature includes values corresponding to the first warm-up mode and the second warm-up mode, respectively.

9. The fuel cell system according to claim 7, wherein
the at least one of the temperature reference value for determining warm-up completion, the predetermined time, and the temperature reference value for determining normal temperature includes the values in which a value corresponding to the second warm-up mode is greater than a value corresponding to the first warm-up mode.

10. The fuel cell system according to claim 8, wherein
the at least one of the temperature reference value for determining warm-up completion, the predetermined time, and the temperature reference value for determining normal temperature includes the values in which a value corresponding to the second warm-up mode is greater than a value corresponding to the first warm-up mode.

11. The fuel cell system according to claim 7, further comprising:
a power storage device configured to be charged with power output from the fuel cell stack,
wherein the first output and the second output are target power output from the fuel cell stack, and
wherein the one or more processors execute the computer-executable instructions to cause the fuel cell system to:
switch the first warm-up mode and the second warm-up mode based on a state of charge of the power storage device.

12. The fuel cell system according to claim 8, further comprising:
a power storage device configured to be charged with power output from the fuel cell stack,
wherein the first output and the second output are target power output from the fuel cell stack, and
wherein the one or more processors execute the computer-executable instructions to cause the fuel cell system to:
switch the first warm-up mode and the second warm-up mode based on a state of charge of the power storage device.

13. A control method of a fuel cell system executed by one or more processors, the control method comprising:
determining a voltage drop of the fuel cell stack at low-temperature startup by low-temperature startup control performed in a case where a temperature of a fuel cell stack configured to generate electric power by reactions between an anode gas and a cathode gas is lower than a low-temperature threshold, or at normal startup by normal startup control performed in a case where the temperature is equal to or higher than the low-temperature threshold; and
performing a voltage recovery control by increasing a cathode gas flow rate in response to the voltage drop of the fuel cell stack at low-temperature startup by the low-temperature startup control or at normal startup by the normal startup control, wherein
in performing a voltage recovery control, setting an increase in the cathode gas flow rate until the fuel cell stack reaches a predetermined water-content state in the voltage recovery control during the low-temperature startup to be smaller than an increase in the cathode gas flow rate during the normal startup.
